(19) United States
(12) Patent Application Publication
(10) Pub. No.: US 2001/0009686 A1
(43) Pub. Date: Jul. 26, 2001

(54) FORMULATED LOW MOISTURE EGG PRODUCT

(76) Inventors: JONATHAN A. MERKLE, GREEN ISLE, MN (US); DANA R. BALDWIN, ALBANY, GA (US)

Correspondence Address: EDWIN E. VOIGT II, VIDAS, ARRETT STEINKRAUS, P.A., SUITE 2000, 6109 BLUE CIRCLE DRIVE, MINNETONKA, MN, 553439131

(21) Appl. No.: 09/248,805

(22) Filed: Feb. 12, 1999

Related U.S. Application Data
(60) Provisional application No. 60/107,448, filed on Nov. 6, 1998.

(51) Int. Cl. A23B 5/00

(52) U.S. Cl. 426/614; 426/89

(57) ABSTRACT

The formulated cooked low moisture egg product in general includes physical chemical characteristics providing a water activity of approximately 0.94 or lower and preferably 0.93 which is significantly less than the normal water activity of egg products of approximately 0.98 The formulated low moisture egg product in general is formed of whole egg having a percentage of weight as compared to the entire product of between 55% and 65.7%; egg yolk having a percentage weight of between 0% and 25%; glycerin having a percentage weight of between 0% and 5.5%; carbohydrate-bulking having a percentage weight of between 0% and 3.2%; salt having a percentage weight of approximately 2.5%; edible oil having a percent weight of between 10% and 10.2%; dry egg having a percent weight of between 3% and 13%; starch having a percentage weight of approximately 3%; and carbohydrate-gelling having a percentage weight of between 0.3% and 0.5% where the total percentage by weight of the formulated low moisture egg product is 100% prior to cooking.

The present invention relates to a formulated low moisture egg product and is based upon U.S. Provisional patent application No. 60/107,448, filed Nov. 6, 1998.

### BACKGROUND OF THE INVENTION

The present invention is directed to a formulated low moisture egg product which has a water activity of less than 0.94. The formulated low moisture cooked egg product is primarily used as an ingredient within enrobed, breaded, or other food items such as pastry in which moisture transfer from the egg material into the desired final product would be undesirable.

In the past egg products used as constituents or components of a desired packaged food product have included a base line water activity of approximately 0.98 even following cooking. The base line water activity for a final desired food product such as bread is approximately 0.93 A high chemical potential exists for moisture migration between the constituent egg products and the desired final food products prior to and after cooking of the final food product. Sufficient potential for moisture migration is generally present to drive moisture into a final food product even following cooking. This moisture migration is especially problematic when the desired final food product is a bread or pastry product. Moisture migration between the known egg products and the desired final bread or pastry product often results in softening or sogginess of the final product resulting in significant waste.

In the past, efforts have been implemented to attempt to deter moisture migration by physically separating the egg products from the remaining constituents within the product packaging by the use of a physical barrier. This technique normally results in significantly higher packaging expense to a manufacturer.

In the past there has been no known method which is cost effective, and which minimizes moisture migration from egg products within pre-mixed or cooked food products A need exists to formulate an egg product which has a reduced moisture or water activity to minimize moisture or water migration within pre-packaged or cooked food products such as bread and/or pastry The elimination of wasteful packaging may then be accomplished while simultaneously improving the quality of a final desired food product.

### SUMMARY OF THE INVENTION

The formulated low moisture egg product in general includes physical chemical characteristics providing a water activity of approximately 0.94 or lower and preferably 0.93 which is significantly less than the normal water activity of egg products of approximately 0.98. The formulated low moisture egg product thereby minimizes moisture migration between food constituents even following cooking, thereby eliminating undesirable softening or sogginess within a final food product. The formulated low moisture egg product in general is formed of whole egg having a percentage of weight as compared to the entire product of between 55% and 65 7%; egg yolk having a percentage weight of between 0% and 25%; glycerine having a percentage weight of between 0% and 5.5%; carbohydrate-bulking having a percentage weight of between 0% and 3.2%; salt having a percentage weight of approximately 2.5%; edible oil having a percentage weight of between 10% and 10.2%; dry egg having a percentage weight of between 3% and 13%; starch having a percentage weight of approximately 3%; and carbohydrate-gelling having a percentage weight of between 0.3% and 0.5% where the total percentage by weight of the formulated low moisture egg product is 100%.

A principal object of the present invention is to provide a cooked formulated low moisture egg product of relatively simple and inexpensive composition which is also easy to manufacture and use and which is safe and which fulfills the intended purpose of reducing moisture migration within packaged food products without fear of sickness to persons and/or spoilage of the food products.

Another principal object of the present invention is to provide a cooked formulated low moisture egg product which is easy to cook with other food ingredients or constituents for packaging into a final desired food product.

Still another principal object of the present invention is to provide a formulated low moisture egg product having physical and chemical characteristics indistinguishable from a standard egg product with the exception of a reduced water activity.

Still another principal object of the present invention is to provide a formulated low moisture egg product which eliminates the necessity for physical barriers used to separate food constituents within packaged food items.

Still another principal object of the present invention is the provision a cooked formulated low moisture egg product which is sensorially indistinguishable from standard egg products within a final food product to be consumed by an individual.

Still another principal object of the present invention is to provide a cooked formulated low moisture egg product which is robust and sturdy and which withstands degradation when mixed for cooking into a final desired food product.

A feature of the present invention is the provision of a formulated low moisture egg product having whole egg in a percentage by weight of between 55% and 65.7% where the whole egg may be liquid pasteurized or unpasteurized.

Another feature of the present invention is the provision of a formulated low moisture egg product having egg yolk in a percentage by weight of between 0% and 25% where the egg yolk may be pasteurized or unpasteurized.

Still another feature of the present invention is the provision of a formulated low moisture egg product having glycerine in a percentage by weight of between 0% and 5.5%.

Still another feature of the present invention is the provision of a formulated low moisture egg product having carbohydrate-bulking of between 0% and 3.2% by weight where the carbohydrate-bulking may be formed of maltodextrin, modified starches, dextrose, or other starches.

Still another feature of the present invention is the provision of a formulated low moisture egg product having salt of approximately 2.5% by weight.

Still another feature of the present invention is the provision of a formulated low moisture egg product having edible oil of between 10% and 10.25% by weight where the oil may be soybean oil, corn oil, peanut oil, or any other preferred vegetable or other edible oil as desired by an individual.

Still another feature of the present invention is the provision of a formulated low moisture egg product having dry egg of between 3% and 13% by weight where the dry egg may be dried or powdered whole egg, dry or powdered egg yolk, or dry or powdered egg white

Still another feature of the present invention is the provision of a formulated low moisture egg product having starch of approximately 3% by weight.

Still another feature of the present invention is the provision of a formulated low moisture egg product having carbohydrate-gelling of between 0.3% and 0.5% by weight where the carbohydrate-gelling may be formed of CMC or carboxymethylcellulose, xanthin, carrageenan or guar gums.

This utility application is based upon provisional patent application serial No. 60/107,488, filed Nov. 6, 1998, for “Formulated Low Moisture Egg Product” which is incorporated by reference herein.

### DETAILED DESCRIPTION OF THE PREFERRED EMBODIMENT

Brief Description

This invention embodies a range of egg product formulations which are formulated so that when cooked, the resulting product has a water activity of less than 0 94 and preferably 0.93 This product is ideal for use in enrobed, breaded, or other items (e.g., pastry) in which moisture transfer from the egg material into another would be undesirable.

This invention includes a formulation and finished product which is distinctly different in certain physical-chemical characteristics from standard formulated egg products but which is sensorially acceptable as a formulated egg product. Most formulated egg products have a water activity of greater than or equal to 0.98. Bread or pastry based materials typically have a water activity of about 0.93. When a standard formulated egg product (water activity 0.98) is cooked, mixed, cooked to a final product, and packaged as a bread or pastry product (water activity 0 93), a high chemical potential exists between the water in the two materials which drives the water from the egg product into the bread or pastry product. This moisture migration results in a softening or sogginess in the bread or pastry product which is undesirable. An attempted solution to this problem of moisture migration is to place a physical barrier between the materials This invention utilizes another means, by formulating the egg product to have a water activity near that of the final bread or pastry product, moisture migration may be slowed or eliminated

In this invention, the egg product is formulated so that after cooking it has a water activity of less than 0.93. This is accomplished using standard egg ingredients combined with standard carbohydrates and low molecular weight compounds which increase the solids and lower the water activity.

Several examples of this formulation approach are listed in the table below

Example Formulas

| Ingredient | 1 | 2 | 3 | 4 | 5 | 6 |
|---|---|---|---|---|---|---|
| Whole egg | 55.00% | 57.20% | 55.00% | 55.20% | 65.70% | 58.00% |
| Egg yolk | 25.00% | 21.00% | 20.00% | 21.00% | 0.00% | 14.00% |
| Glycerin | | 3.00% | 3.00% | 5.00% | 5.50% | 525% |
| Carbohydrate - | | | | | | |
| bulking | | | 3.20% | | | 2.00% |
| Salt | 2.50% | 2.50% | 2.50% | 2.50% | 2.50% | 2.50% |
| Oil | 10.20% | 10.00% | 10.00% | 10.00% | 1000% | 1000% |
| Dry Egg | 4.00% | 3.00% | 3.00% | 3.00% | 1300% | 4.75% |
| Starch | 3.00% | 3.00% | 3.00% | 300% | 300% | 300% |
| Carbohydrate - | 0.30% | 0.30% | 0.30% | 0.30% | 030% | 0.50% |
| gelling | | | | | | |
| | 100.00% | 100.00% | 100.00% | 100.00% | 10000% | 10000% |

Detailed Description

The formulated low moisture egg product preferably has the physical chemical characteristics of standard formulated egg products. The formulated low moisture egg product described herein is preferably sensorially acceptable as a formulated egg product in substitution for a standard egg product in cooking activities. Preferably the formulated low moisture egg product has a water activity of 0.94 or less and preferably 0.93.

The formulated low moisture egg product having a reduced water activity minimizes water or moisture migration within the precooked food products which significantly reduces or eliminates sogginess or softening of the final food product following reheating

Moisture migration occurs as a chemical process to drive water from a compound having a high water activity to a compound having a relatively lower water activity to achieve an equilibrium water level. Moisture migration is especially problematic within prepackaged cooked food products.

If formulated precooked egg products having a standard water activity are cooled and then mixed with other desired food constituents for further cooking into a desired final food product, then moisture migration between the standard egg products and the other food constituents may occur which in turn results in sogginess and/or softening of the final food product.

In addition, if standard formulated precooked egg products are mixed and packaged for further reheating at a future time, then the shelf life of the product generally provides sufficient time for moisture migration to occur between the product constituents which results in the softening or sogginess of the desired food product. Moisture migration is especially problematic in food items such as bread and pastry. Moisture migration in these instances results in significant waste of food.

The water activity level for bread and pastry is typically 0.93 and the water activity level for standard formulated cooked egg products is approximately 0.98. Therefore, a relatively high chemical potential exists for moisture migration between the two food constituents sufficient to drive water from the unformulated standard egg product into the bread and/or pastry product This moisture migration results again in softening or sogginess of a final bread or pastry product even following reheating or cooking.

The formulated low moisture egg product eliminates the necessity to place a physical barrier between constituents of food products prior to cooking.

In order to reduce the water activity of the formulated low moisture egg product to a level substantially identical to a bread or pastry product, which thereby eliminates the undesirable effect of moisture migration, various standard egg ingredients are combined with standard carbohydrates and low molecular weight compounds, generally identified as additives herein, which increase the percent by weight of solids and reduce the water activity level for the formulated low moisture egg product.

The standard egg ingredients, standard carbohydrates, and low molecular weight compounds or additives may generally be described as egg yolk, glycerin, carbohydrate-bulking, salt, edible oils, dry eggs, starch, and carbohydrate-gelling.

The egg yolk added to the formulated low moisture egg product may be separated from whole eggs in a conventional manner and may be either pasteurized or unpasteurized at the discretion of an individual. Generally, the percent by weight of added egg yolk material varies between 0% and 25% based upon the weight of the entire formulated low moisture egg product.

Generally the percent by weight of glycerin added to the formulated low moisture egg product varies between 0% and 5.5% based upon the weight of the entire formulated low moisture egg product.

The carbohydrate-bulking material added to the formulated low moisture egg product may be formed of maltodextrin, modified starches, dextrose, or other starches as desired by an individual. Generally the percent by weight of the added carbohydrate-bulking material varies between 0% and 3.2% based upon the weight of the entire formulated low moisture egg product

Generally the percent by weight of the salt added to the formulated low moisture egg product is approximately 2.5% based upon the weight of the entire formulated low moisture egg product.

The edible oil added to the formulated low moisture egg product may be selected from soybean oil, corn oil, peanut oil, vegetable oil, and/or any other edible oils as desired by an individual. Generally the percent by weight of the added edible oil varies between 10% and 10.25% based upon the weight of the entire formulated low moisture egg product

The whole egg material added to the formulated low moisture egg product may be pasteurized or unpasteurized at the discretion of an individual. Generally the percent by weight of the whole egg material varies between 55% and 65.7% based upon the entire weight of the formulated low moisture egg product.

The dry egg material added to the formulated low moisture egg product may be formed of dry or powdered whole egg, dry or powdered egg yolk, or dry or powdered egg whites at the discretion of an individual. Generally, the percent by weight of the added dry egg material varies between 3% and 13% based upon the weight of the entire formulated low moisture egg product.

Generally the percent by weight of starch added to the formulated low moisture egg product is 3% based upon the weight of the entire formulated low moisture egg product

The carbohydrate-gelling material added to the formulated low moisture egg product may be selected of CMC or carboxymethylcellulose, xanthin, carrageenan or guar gums at the discretion of an individual. Generally the percent by weight of the added carbohydrate-gelling material varies between 0.3% and 0.5% based upon the weight of the entire formulated low moisture egg product.

More specifically, one embodiment of the invention would include a formulated low moisture egg product formed of whole egg at 55%; egg yolk at 25%; salt at 2.5%; edible oil at 10.2%; dry egg at 4%; starch at 3%; and carbohydrate-gelling at 0.3% of the total weight for the formulated low moisture egg product. In this embodiment, the water activity for the formulated low moisture egg product was reduced to 0.93, significantly decreasing moisture migration between the constituents of a prepackaged food product even following cooking

Another embodiment of the formulated low moisture egg product would be formed of whole egg 57.2%; egg yolk 21%; glycerin 3%; salt 2.5%; edible oil 10%, dry egg 3%; starch 3%; and carbohydrate-gelling 0.3% of the total weight of the formulated low moisture egg product. In this embodiment, the water activity for the formulated low moisture egg product was reduced to 0.93, significantly decreasing moisture migration between the constituents of a prepackaged food product even following cooking.

Still another embodiment of the formulated low moisture egg product would be formed of whole egg 55%; egg yolk 20%; glycerin 3%; carbohydrate-bulking 3 2%; salt 2 5%; edible oils 10%; dry egg 3%; starch 3%; and carbohydrate-gelling at 0.3% of the total weight of the formulated low moisture egg product. In this embodiment, the water activity for the formulated low moisture egg product was reduced to 0.93, significantly decreasing the moisture migration between the constituents of a prepackaged food product even following cooking.

Still another embodiment of the formulated low moisture egg product would be formed of whole egg 55.2%; egg yolk 21%; glycerin 5%; salt 2.5%; edible oils 10%; dry egg 3%, starch 3%; and carbohydrate-gelling at 0.3% of the total weight of the formulated low moisture egg product In this embodiment, the water activity for the formulated low moisture egg product was reduced to 0.93, significantly decreasing moisture migration between the constituents of a prepackaged food product even following cooking.

Still another embodiment of the formulated low moisture egg product would be formed of whole egg 65.7%; glycerin 5.5%; salt 2.5%; edible oils 10%; dry egg 13%; starch 3%, and carbohydrate-gelling 0.3% based upon the entire weight of the formulated low moisture egg product. In this embodiment, the water activity for the formulated low moisture egg product was reduced to 0.93, significantly decreasing moisture migration between the constituents of a prepackaged food product even following cooking.

Still another embodiment of the formulated low moisture egg product would be formed of whole egg 58%; egg yolk 14%; glycerin 5.25%; carbohydrate-bulking 2%; salt 2.5%; edible oils 10%; dry egg 4.75%; starch 3%; and carbohydrate-gelling 0.5% based upon the entire weight of the formulated low moisture egg product. In this embodiment, the water activity for the formulated low moisture egg product was reduced to 0.93, significantly decreasing moisture migration between the constituents of a prepackaged food product even following cooking

### EXAMPLE 1

The ingredients of 330 pounds. liquid whole egg, 150 pounds liquid yolk, and 61 2 pounds oil were added to a mix tank and mixed with an Admix high shear mixer for five minutes at a speed of 3,450 RPM resulting in a homogeneous liquid product.

The ingredients of 15 pounds salt, 24 pounds dry egg white, 18 pounds starch, and 1.8 pounds carrageenan were added to the mix sequentially while the mix was agitated and the high shear mixer continued to mix the product at 3,450 RPM. After incorporation of these ingredients, the liquid product was mixed for an additional ten minutes to ensure a homogenous product

The mixed liquid egg product was preheated and deposited in a thickness of ¼ inch onto a continuous oven belt. The formulated low moisture product was then cooked at approximately 350° F. for three minutes. The temperature and time were adjusted to ensure a thoroughly cooked product.

The formulated low moisture egg product was evaluated after cooling and/or freezing to determine the water activity by placing a small amount of diced product into sample cup The sample was equilibrated to room temperature and then a dew point measuring device (e g, Decagon Aqualab CX-3) was utilized to determine the water activity (equilibrium relative humidity/100) of the sample.

### EXAMPLE 2

The ingredients of 343.2 pounds liquid whole egg, 126 pounds liquid yolk, and 60 pounds oil were added to a mix tank and mixed with an Admix high shear mixer for five minutes a speed of 3,450 RPM resulting in a homogeneous liquid product.

The ingredients of 18 pounds glycerin, 15 pounds salt, 18 pounds dry egg white, 18 pounds starch, and 1.8 pounds carrageenan were added to the mix sequentially while the mix was agitated and the high shear mixer continued to mix the product at 3,450 RPM After incorporation of these ingredients, the liquid product was mixed for an additional ten minutes to ensure a homogenous product.

The mixed liquid egg product was preheated and deposited in a thickness of ¼ inch onto a continuous oven belt. The formulated low moisture product was then cooked at approximately 350° F. for three minutes. The temperature and time were adjusted to ensure a thoroughly cooked product.

The formulated low moisture egg product was evaluated after cooling and/or freezing to determine the water activity by placing a small amount of diced product in to a sample cup. The sample was equilibrated to room temperature and then a dew point measuring device (e.g, Decagon Aqualab CX-3) was utilized to determine the water activity (equilibrium relative humidity/100) of the sample.

### EXAMPLE 3

The ingredients of 330 pounds liquid whole egg, 120 pounds liquid yolk, and 60 pounds oil were added to a mix tank and mixed with an Admix high shear mixer for five minutes a speed of 3,450 RPM resulting in a homogeneous liquid product.

The ingredients of 18 pounds glycerin, 19.2 pounds maltodextrin, 15 pounds salt, 18 pounds dry egg white, 18 pounds starch, and 1.8 pounds carrageenan were added to the mix sequentially while the mix was agitated and the high shear mixer continued to mix the product at 3,450 RPM. After incorporation of these ingredients, the liquid product was mixed for an additional ten minutes to ensure a homogenous product.

The mixed liquid egg product was preheated and deposited in a thickness of ¼ inch onto a continuous oven belt. The formulated low moisture product was then cooked at approximately 350° F. for three minutes. The temperature and time were adjusted to ensure a thoroughly cooked product.

The formulated low moisture egg product was evaluated after cooling and/or freezing to determine the water activity by placing a small amount of diced product in to a sample cup. The sample was equilibrated to room temperature and then a dew point measuring device (e.g., Decagon Aqualab CX-3) was utilized to determine the water activity (equilibrium relative humidity/100) of the sample.

### EXAMPLE 4

The ingredients of 331.2 pounds liquid whole egg, 126 pounds liquid yolk, and 60 pounds oil were added to a mix tank and mixed with an Admix high shear mixer for five minutes a speed of 3,450 RPM resulting in a homogeneous liquid product.

The ingredients of 30 pounds glycerin, 15 pounds salt, 18 pounds dry egg white, 18 pounds starch, and 1.8 pounds carrageenan were added to the mix sequentially while the mix was agitated and the high shear mixer continued to mix the product at 3,450 RPM After incorporation of these ingredients, the liquid product was mixed for an additional ten minutes to ensure a homogenous product.

The mixed liquid egg product was preheated and deposited in a thickness of ¼ inch onto a continuous oven belt. The formulated low moisture product was then cooked at approximately 350° F. for three minutes. The temperature and time were adjusted to ensure a thoroughly cooked product.

The formulated low moisture egg product was evaluated after cooling and/or freezing to determine the water activity by placing a small amount of diced product in to a sample cup The sample was equilibrated to room temperature and then a dew point measuring device (e g, Decagon Aqualab CX-3) was utilized to determine the water activity (equilibrium relative humidity/100) of the sample.

### EXAMPLE 5

The ingredients of 394.2 pounds liquid whole egg and 60 pounds oil were added to a mix tank and mixed with an Admix high shear mixer for five minutes a speed of 3,450 RPM resulting in a homogeneous liquid product.

The ingredients of 33 pounds glycerin, 15 pounds salt, 78 pounds dry egg white, 18 pounds starch, and 1.8 pounds carrageenan were added to the mix sequentially while the mix was agitated and the high shear mixer continued to mix the product at 3,450 RPM. After incorporation of these ingredients, the liquid product was mixed for an additional ten minutes to ensure a homogenous product.

The mixed liquid egg product was preheated and deposited in a thickness of ¼ inch onto a continuous oven belt. The formulated low moisture product was then cooked at approximately 350° F. for three minutes. The temperature and time were adjusted to ensure a thoroughly cooked product.

The formulated low moisture egg product was evaluated after cooling and/or freezing to determine the water activity by placing a small amount of diced product in to a sample cup. The sample was equilibrated to room temperature and then a dew point measuring device (e.g, Decagon Aqualab CX-3) was utilized to determine the water activity (equilibrium relative humidity/100) of the sample

### EXAMPLE 6

The ingredients of 348 pounds liquid whole egg, 84 pounds liquid yolk, and 60 pounds oil were added to a mix tank and mixed with an Admix high shear mixer for five minutes a speed of 3,450 RPM resulting in a homogeneous liquid product.

The ingredients of 31.5 pounds glycerin, 15 pounds salt, 12 pounds maltodextrin, 28 5 pounds whole egg, 18 pounds starch, and 3 pounds carrageenan were added to the mix sequentially while the mix was agitated and the high shear mixer continued to mix the product at 3,450 RPM. After incorporation of these ingredients, the liquid product was mixed for an additional ten minutes to ensure a homogenous product.

The mixed liquid egg product was preheated and deposited in a thickness of ¼ inch onto a continuous oven belt. The formulated low moisture product was then cooked at approximately 350° F. for three minutes. The temperature and time were adjusted to ensure a thoroughly cooked product.

The formulated low moisture egg product was evaluated after cooling and/or freezing to determine the water activity by placing a small amount of diced product in to a sample cup The sample was equilibrated to room temperature and then a dew point measuring device (e.g Decagon Aqualab CX-3) was utilized to determine the water activity (equilibrium relative humidity/100) of the sample.

The formulated low moisture egg product as disclosed herein is also robust and sturdy and withstands degradation when cooked and then mixed for use in cooking of final desired food products, where the formulated low moisture egg product has performance characteristics similar to standard formulated egg products used in cooking activities.

The present invention may be embodied in other specific forms without departing from the spirit or essential attributes thereof; and it is, therefore, desired that the present embodiment be considered in all respects as illustrative and not restrictive, reference being made to the appended claims rather than to the foregoing description to indicate the scope of the invention.

I claim:

1. A formulated low moisture egg product comprising:
a) whole egg;
b) egg yolk;
c) salt;
d) edible oil;
e) dry egg;
f) starch; and
g) carbohydrate-gelling;
wherein the water activity of the formulated low moisture egg product is less than or equal to 0.94.

2. A formulated low moisture egg product of claim 1, wherein the amount of whole egg is 55% by weight, the amount of egg yolk is 25% by weight, the amount of salt is 2.5% by weight, the amount of edible oil is 10.2% by weight, the amount of dry egg is 4% by weight, the amount of starch is 3% by weight, and the amount of carbohydrate-gelling is 0.3% by weight.

3. A formulated low moisture egg product of claim 1, wherein the edible oil is selected from the group consisting of soybean oil, corn oil, peanut oil, and vegetable oils

4. A formulated low moisture egg product of claim 1, wherein the dry egg is selected from the group consisting of dry whole egg, dry egg yolk, and dry egg white.

5. A formulated low moisture egg product of claim 1, wherein the carbohydrate-gelling is selected from the group consisting of carboxymethylcellulose, xanthin, carrageenan and guar gums.

6. A formulated low moisture egg product of claim 1, wherein the formulated low moisture egg product is cooked.

7. A formulated low moisture egg product comprising:
a) whole egg;
b) egg yolk.
c) glycerin;
d) salt;
e) oil;
f) dry egg,
g) starch; and
h) carbohydrate-gelling;
wherein the water activity of the formulated low moisture egg product is less than or equal to 0.94.

8. A formulated low moisture egg product of claim 7, wherein the amount of whole egg is 57.2% by weight, the amount of egg yolk is 21% by weight, the amount of glycerin is 3% by weight, the amount of salt is 2.5% by weight, the amount of edible oil is 10% by weight, the amount of dry egg is 3% by weight, the amount of starch is 3% by weight, and the amount of carbohydrate-gelling is 0.3% by weight.

9. A formulated low moisture egg product of claim 7, wherein the edible oil is selected from the group consisting of soybean oil, corn oil, peanut oil, and vegetable oils.

10. A formulated low moisture egg product of claim 7, wherein the dry egg is selected from the group consisting of dry whole egg, dry egg yolk, and dry egg white

11. A formulated low moisture egg product of claim 7, wherein the carbohydrate-gelling is selected from the group consisting of carboxymethylcellulose, xanthin, carrageenan and guar gums.

12. A formulated low moisture egg product of claim 7, wherein the amount of whole egg is 55.2% by weight, the amount of egg yolk is 21% by weight, the amount of glycerin is 5% by weight, the amount of salt is 2.5% by weight, the amount of edible oil is 10% by weight, the amount of dry egg is 3% by weight, the amount of starch is 3% by weight, and the amount of carbohydrate gelling is 0.3% by weight.

13. A formulated low moisture egg product of claim 7, wherein the amount of whole egg is 65.7% by weight, the amount of egg yolk is 0% by weight, the amount of glycerin is 5 5% by weight, the amount of salt is 2.5% by weight, the amount of edible oil is 10% by weight, the amount of dry egg is 13% by weight, the amount of starch is 3% by weight, and the amount of carbohydrate-gelling is 0.3% by weight.

14. A formulated low moisture egg product of claim 7, wherein the formulated low moisture egg product is cooked.

15. A formulated low moisture egg product comprising:
a) whole egg;
b) egg yolk;
c) glycerin
d) carbohydrate-bulking
e) salt;
f) oil;
g) dry egg;
h) starch; and
i) carbohydrate-gelling;
wherein the water activity of the formulated low moisture egg product is less than or equal to 0.94.

16. A formulated low moisture egg product of claim 15, wherein the amount of whole egg is 55% by weight, the amount of egg yolk is 20% by weight, the amount of glycerin is 3% by weight, the amount of carbohydrate-bulking is 3.2% by weight, the amount of sale is 2 5% by weight, the amount of edible oil is 10% by weight, the amount of dry egg is 3% by weight, the amount of starch is 3% by weight, and the amount of carbohydrate-gelling is 3% by weight

17. A formulated low moisture egg product of claim 15, wherein the edible oil is selected from the group consisting of soybean oil, corn oil, peanut oil, and vegetable oils

18. A formulated low moisture egg product of claim 15, wherein the dry egg is selected from the group consisting of dry whole egg, dry egg yolk, and dry egg white

19. A formulated low moisture egg product of claim 15, wherein the carbohydrate-gelling is selected from the group consisting of carboxymethylcellulose, xanthin, carrageenan and guar gums.

20. A formulated low moisture egg product of claim 15, wherein the amount of whole egg is 58% by weight, the amount of egg yolk is 14% by weight, the amount of glycerin is 5 25% by weight, the amount of carbohydrate-bulking is 2% by weight, the amount of salt is 2 5% by weight, the amount of edible oil is 10% by weight, the amount of dry egg is 4 75% by weight, the amount of starch is 3% by weight, and the amount of carbohydrate-gelling is 5% by weight

21. A formulated low moisture egg product of claim 15, wherein the carbohydrate-bulking is selected from the group consisting of maltodextrin, dextrose, and starches

22. A formulated low moisture egg product of claim 15, wherein the formulated low moisture egg product is cooked.
